(19) United States
(12) Patent Application Publication
(10) Pub. No.: US 2007/0146157 A1
(43) Pub. Date: Jun. 28, 2007

(54) Method for communicating between an order transmitter and an order receiver-transmitter

(76) Inventor: Michel Ramus, Amancy (FR)

Correspondence Address: Ronald R Santucci;Frommer Lawrence & Haug, 745 Fifth Avenue, New York, NY, 10151, US

(21) Appl. No.: 10/542,151

(22) PCT Filed: Jan. 9, 2004
(86) PCT No.: PCT/IB04/00120

§ 371 Date: Aug. 28, 2006

(51) Int. Cl. H04L 9/32

(52) U.S. Cl. 340/825.22; 340/825.72; 455/73; 340/5.61; 340/5.22; 340/825.69

(57) ABSTRACT

The inventive method makes it possible to communicate between an order transmitter and a bi-directional order transmitter-receiver for controlling elements which ensure the security or comfort of a building. The transmission of control orders from the order transmitter to the order transmitter-receiver or from said order transmitter-receiver to other elements is carried out by means of frequency modulated radioelectric signals. Said method is characterised in that in a programming mode, the order transmitter-receiver successively activates and interrupts the emission of electric signals traditionally used for communicating in a frequency modulation mode in such a way that it is possible to transmit data to the order transmitter by means of said frequency modulated radioelectric signals.

### BACKGROUND OF THE INVENTION

The invention relates to a method of communication between a command transmitter and a bi-directional command transmitter-receiver that are intended for the control of elements ensuring the security and/or comfort of a building, the communication of control commands from the command transmitter to the command transmitter-receiver or from the transmitter-receiver to other elements, being done by way of frequency-modulated RF signals. It relates moreover to a command transmitter-receiver for the implementation of this method and to an installation comprising such a command transmitter-receiver and transmitter.

An installation comprising command transmitters and command receivers is used for example to control motorized devices such as shutters, roller blinds or else to control lights or alarm systems.

These installations typically comprise one or more command transmitters. Each controlled device is associated with a command receiver. Provision may however be made for a command receiver to drive several devices.

When the command transmitters and the command receivers communicate remotely, in particular by using an electromagnetic signal and especially an RF signal, it is necessary, in one and the same installation, for the command transmitters to be paired with the command receivers.

This pairing procedure may take several forms.

### DESCRIPTION OF THE PRIOR ART

U.S. Pat. No. 4,750,118 discloses a pairing procedure making it possible to record the respective identifiers of a plurality of command transmitters in a memory situated in a command receiver. During functional operation, the command receiver validates the commands received only after having ascertained that the latter originate from a command transmitter whose identifier has previously been recorded. This solution involves allocating an identifier to each command transmitter during its manufacture.

Another known solution consists in assigning a unique identifier to the command receiver. This identifier is communicated, during a programming operation, to each of the control command transmitters.

For example, U.S. Pat. No. 5,148,159 describes a system in which the identifier of a command receiver is communicated to command transmitters through an asynchronous type serial transmission.

Other systems also propose, on the same principle, the random generation of the codes constituting the identifiers of the command receivers. These identifiers are sent from the command receivers to each command transmitter in such a way as to make the transmissions secure.

These procedures make it possible to avoid the need to allocate an identifier to each command transmitter at the time of its manufacture. However, they require, at the level of the command transmitters, means for the reception of the information, that is to say means of bi-directional communication.

These solutions increase the manufacturing costs and, especially, those of the command transmitters. They significantly increase the cost of a control system insofar as several command transmitters are often used to communicate with a single command receiver. Such is the case for example for the control of the opening and closing of garage doors, wherein each user has a command transmitter.

Systems for simplified communication to a command transmitter are known from patent applications DE 196 24 410, EP 0 440 974 and DE 196 25 588.

Application DE 196 24 410 discloses a method of communicating a code from a command receiver to a command transmitter. This communication is carried out by virtue of a low-frequency inductive link. Systems of coils and capacitors are provided at the level of the command receiver or of a programming system and of each command transmitter so as to ensure the sending of the code. This low frequency link involves a shorter range than a high frequency link, but it makes it possible to reduce the costs as compared with a conventional high frequency communication.

Likewise, application EP 0 440 974 discloses an installation for communicating between command transmitters and bi-directional command receivers through different frequencies, so as to differentiate the range and the signals transmitted.

Application DE 196 25 588 discloses a method of communication allowing the sending of an identification code, firstly, from a command receiver to a command transmitter having a simplified receiving part, then from this command transmitter to another command transmitter identical to the previous one. This method makes it possible to simplify the means of reception of the command transmitters as regards the antenna and the multiplexer. The costs are therefore slightly reduced. The range of the communication is also lower.

U.S. Pat. No. 4,988,992 discloses a motorized garage door comprising a command transmitter and a command receiver. The transmitter comprises means of activation of a modulator making it possible to pass to a state in which the sending of signals is possible.

Likewise, application EP 1 267 021 discloses a transmitter comprising means of waking up a microprocessor ensuring the generation of signals to be sent.

### SUMMARY OF THE INVENTION

The aim of the present invention is to propose a method of communication and a command transmitter-receiver affording a solution to the problem cited and improving the methods of communication and the command transmitters-receivers known from the prior art. In particular, the invention proposes a method of bi-directional communication between at least one command transmitter-receiver and a command transmitter whose manufacturing costs are low.

The method according to the invention is characterized in that, in a programming mode, the command transmitter-receiver activates and interrupts successively the transmission of electric signals normally used for communication by frequency modulation, so as to send information to the command transmitter by way of amplitude-modulated RF signals. Insofar as the means of transmission of amplitude-modulated signals use the means of transmission of frequency-modulated signals that already exist, the costs of adaptation of the receiver allowing it to ensure the function of transmission of amplitude-modulated signals are low.

The amplitude modulation communication being implemented especially during pairing procedures, the limited range of this mode of communication does not constitute an inconvenience to the user and makes it possible to circumvent interference with other systems or manipulation errors.

The dependent claims 2 and 3 define variants of this method of communication.

The command transmitter-receiver consisting of frequency-modulated RF signals, comprises, according to the invention, an antenna linked to:
means of reception of frequency-modulated RF signals, and to
means of transmission of frequency-modulated RF signals.

It comprises means of activation and of disabling of the means of transmission for the implementation of the communication method previously defined.

Variant embodiments of the transmitter-receiver are defined by the dependent claims 5 to 7.

The invention further relates to an installation comprising at least one command transmitter-receiver as previously defined and at least one command transmitter furnished with means for transmitting frequency-modulated RF signals and with means for receiving amplitude-modulated RF signals.

The communications from the command transmitters to the command transmitters-receivers are carried out by frequency-modulated signals and the communications from the command transmitters-receivers to the command transmitters are carried out by amplitude-modulated signals.

### DESCRIPTION OF THE DRAWINGS

The appended drawing represents, by way of examples, a command transmitter, and a command transmitter-receiver according to the invention.

FIGS. 1a to 1c are diagrams representing a command transmitter and two command transmitters-receivers as well as the various modes of communication occurring between them.

FIG. 2 is a diagram of a command transmitter-receiver according to the invention.

FIG. 3 is a diagram of a command transmitter according to the invention.

### DESCRIPTION OF THE PREFERRED EMBODIMENTS

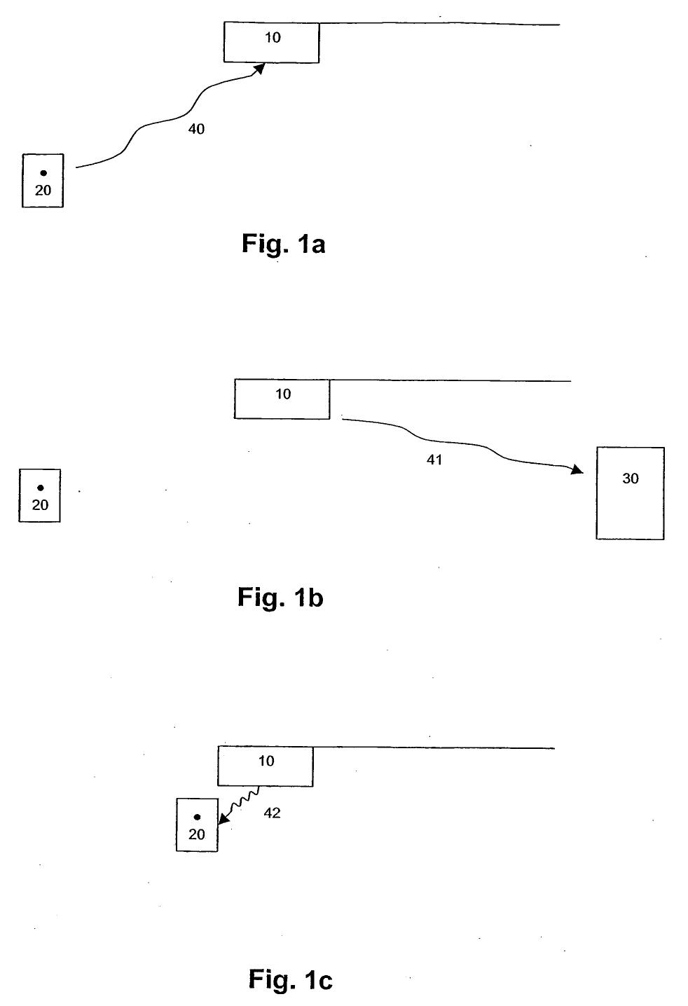

The control installation represented in FIGS. 1a to 1c comprises two command receivers 10, 30 and a command transmitter 20. The command receiver 10 exhibits a function of command transmission (symmetric bi-directional communication), so as to be able to communicate with other elements of the installation. However, for the purposes of clarity, although the command receiver 10 is a transmitter-receiver, in the description it is dubbed a “command receiver”.

The command receiver 10 is able to receive control commands from the command transmitter 20 with which it is associated, in such a way as to drive a piece of comfort and/or security equipment of a building such as a door, a roller blind or an alarm installation. The command receiver 10 can also transmit commands to the other receiver 30 of the installation so as to drive, for example, another piece of equipment of the building. It can operate in ultra high frequency and bi-directionally.

The command transmitter 20 transmits commands by way of electromagnetic waves of radio type at ultra high frequency. The command transmitter 20 communicates with the command receiver 10 in an asymmetric bi-directional manner, that is to say the signals transmitted and received are not modulated in the same way.

The command transmitter 20 transmits frequency-modulated signals to the command receiver 10 as represented by the arrow 40, however, the command transmitter can receive only amplitude-modulated signals.

The command receiver 10 also communicates in an asymmetric bi-directional manner with the command transmitter 20. However, it communicates in a symmetric bi-directional manner with the command transmitter 30 able to receive frequency-modulated signals.

The command receiver 10 is able to transmit, and the command transmitter to receive, amplitude-modulated signals. This communication is based on a low bit rate amplitude modulation of the carrier of the frequency-modulated signal transmitted by the receiver 10. It has a range of the order of 50 cm to 1 m, lower than the range of the frequency-modulated signals.

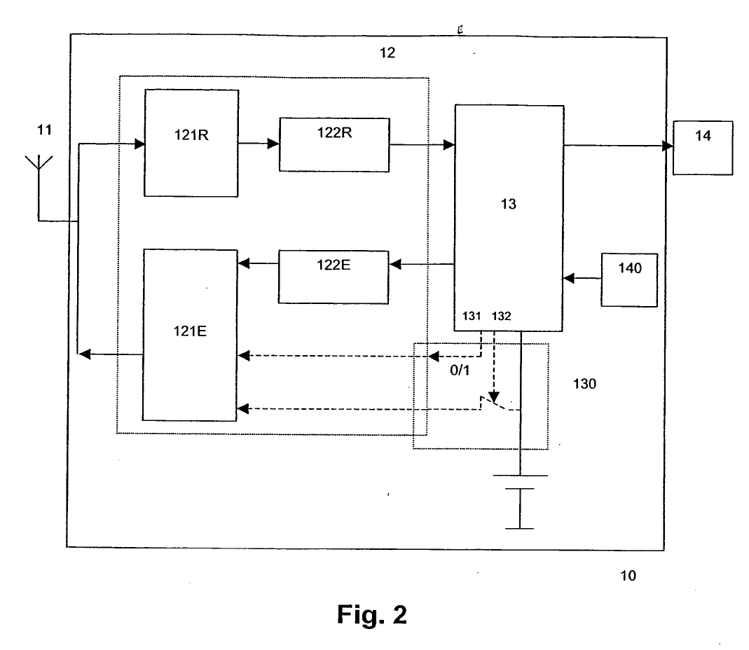

The receiver 10, represented in FIG. 2, comprises a module 12 for transmitting and receiving frequency-modulated signals. This module is connected, on the one hand, to an antenna 11, and, on the other hand, to a logic processing unit 13. It comprises a circuit 121R for amplifying and filtering the signals received by the antenna 11 then a circuit 122R for demodulating the amplified signals. The output of the demodulation circuit is connected to the logic processing unit. Thus, the signals picked up by the antenna are converted through this transmission and reception module 12 into a command that can be interpreted by the logic processing unit which controls a piece of equipment 14.

The module 12 for transmitting and receiving frequency-modulated signals further comprises a circuit 122E for modulating commands from the logic processing unit and a circuit 121E for amplifying these modulated signals, linked to the antenna. Thus, control commands can be sent from the command receiver 10 to the command receiver 30. The elements just previously described are present in the transmitters-receivers known from the prior art.

The circuit 122E for modulation is for example a VCO (Voltage Controlled Oscillator), therefore having an oscillation function. The circuit 121E may then be a simple interrupter for linking to the antenna or for short-circuiting the antenna.

However, the part of the receiver ensuring the signals transmission function exhibits additional elements. It exhibits in particular a module for control of the means of transmission (121E, 122E) of the transmission and reception module 12. This module makes it possible to control the transmission of an amplitude-modulated signal which corresponds to an identifier that the receiver 10 assigns for example in a random manner to the transmitter 20. The sending of such a signal is for example controlled by a means 140 controlling a placing of the command receiver into programming mode. The programming mode corresponds to a mode in which the receiver sends an item of information, of identification code type, to one or more command transmitters. The means 140 for placing in programming mode may for example consist of a push button equipping the command receiver 10 and being linked to its logic processing unit.

The sending of the amplitude-modulated signal is done over a short distance. When the receiver 10 is placed in programming mode, the logic processing unit generates on one of its outputs a signal composed for example of a series of low states and of high states corresponding to an identifier to be assigned to the command transmitter 20. This series of high states and of low states causes via the control module 130 a series of activation and disabling operations of the circuit 121E for amplifying the signals from the modulation circuit 122E. This consequently causes a series of transmissions and interruptions of transmissions of the carrier wave used normally for the frequency-modulation communication. An amplitude-modulated signal is thus obtained. The series of transmissions and of interruptions of transmission of the carrier constitutes the RF signal comprising the message or, in the present case, the identifier to be sent. The carrier wave can be transmitted at a given frequency that is fixed or variable during the amplitude-modulation communications.

The module 130 can also consist of an interrupter controlled by the logic processing unit 13 and connected in series with the supply circuit of the amplification circuit 121E.

Thus, any item of information can be sent at low bit rate from the command receiver 10 to the command transmitter 20. In particular, this item of information may consist of an identification code or an address characterizing the command receiver. This identifier (or address) is subsequently used by the command transmitter to authenticate itself with the command receiver, this time within the framework of a conventional sending of commands carried out via frequency-modulated signals.

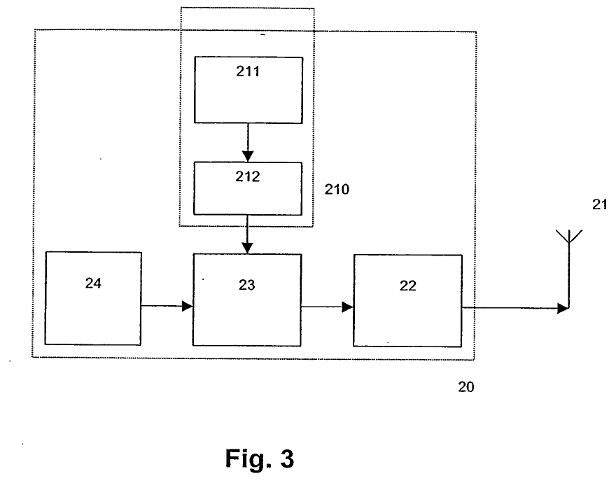

The signal, amplitude-modulated, may easily be detected by an elementary reception module 210 integrated with the command transmitter 20. This command transmitter represented diagrammatically in FIG. 3 comprises a logic processing unit 23 linked, on the one hand, to a user interface 24 of keypad type and, on the other hand, to a circuit 22 for modulation and transmission of frequency-modulated signals. This circuit 22 is itself linked to a coupling device 21. The transmitter furthermore comprises, linked to the logic processing unit 23, an elementary reception module 210. This module allows the reception of amplitude-modulated signals originating from the receiver 10.

This elementary reception module 210 comprises a receiver circuit 211. It may be a receiver circuit of super-regenerative type consisting mainly of a transistor used in oscillation mode. The transistor is blocked in oscillation except for the frequency of the carrier wave used for the communication via frequency-modulated signals. The oscillations are thereafter amplitude-demodulated and shaped by a demodulation circuit 212 translating the signal sent by the receiver 10. Such a type of reception circuit, of low cost, makes it possible easily to detect at low bit rate, two amplitude levels of an amplitude-modulated RF signal.

The elementary reception module 210 therefore makes it possible to receive an “on or off” signal from the transmitter-receiver 10 within a range radius of 50 cm to 1 m and to interpret this signal in the form of a binary code. This code is thereafter stored in a memory of the logic processing unit so as to be sent in the information frames constituting the control commands transmitted by the command transmitter.

The installation described comprises one command transmitter only. However, a plurality of command transmitters such as described, like a plurality of command receivers such as described may constitute an. installation according to the invention.

1. A method of communication between a command transmitter (20) and a bi-directional command transmitter-receiver (10) that are intended for the control of elements (14) ensuring the security and/or comfort of a building, the communication of control commands from the command transmitter (20) to the command transmitter-receiver (10) or from the transmitter-receiver (10) to other elements, being done by way of frequency-modulated RF signals, wherein, in a programming mode, the command transmitter-receiver (10) activates and interrupts successively the transmission of electric signals normally used for communication by frequency modulation, so as to send information to the command transmitter (20) by way of amplitude-modulated RF signals.

2. The method of communication as claimed in claim 1, wherein the information sent to the command transmitter (20) is a series of transmissions and of interruptions of transmissions of a carrier that are carried out by means of transmissions (121E, 122E) of frequency-modulated RF signals of the command transmitter-receiver.

3. The method of communication as claimed in claim 1, wherein the information comprises an identification code.

4. A transmitter-receiver (10) of commands consisting of frequency-modulated RF signals, comprising an antenna (11) linked to:
means of reception (121R, 122R) of frequency-modulated RF signals, and to
means of transmission (121E, 122E) of frequency-modulated RF signals,
which comprises means (13, 130) of activation and of disabling of the means of transmission (121E, 122E) for the implementation of the method as claimed in claim 1.

5. The transmitter-receiver (10) of commands as claimed in claim 4, wherein the means (13, 130) of activation and of disabling allow the activation and disabling of an amplifying circuit (121E) of the transmission means.

6. The transmitter-receiver (10) of commands as claimed in claim 5, wherein the means (13, 130) of activation and of disabling of the amplifying circuit (121E) comprise a logic processing unit (13) and a control circuit (130).

7. The transmitter-receiver (10) of commands as claimed in claim 5, wherein the means (13, 130) of activation and of disabling comprise means (130) of control of the power supply of the amplifying circuit (121E).

8. An installation comprising at least one command transmitter-receiver (10) as claimed in claim 4 and at least one command transmitter (20) furnished with means (22) for transmitting frequency-modulated RF signals and with means (210) for receiving amplitude-modulated RF signals.
